(19) United States
(12) Patent Application Publication
(10) Pub. No.: US 2021/0276645 A1
(43) Pub. Date: Sep. 9, 2021

(54) MODULAR SENSOR BAY FOR A CONSTRUCTION MACHINE

(71) Applicant: CATERPILLAR PAVING PRODUCTS INC., Brooklyn Park, MN (US)

(72) Inventors: Timothy Michael O'DONNELL, Long Lake, MN (US); Jacob McALPINE, Ostego, MN (US); Todd IMPOLA, Minnetonka, MN (US); John Lee MARSOLEK, Watertown, MN (US)

(73) Assignee: CATERPILLAR PAVING PRODUCTS INC., Brooklyn Park, MN (US)

(21) Appl. No.: 17/143,540

(22) Filed: Jan. 7, 2021

Related U.S. Application Data
(60) Provisional application No. 62/985,473, filed on Mar. 5, 2020.

(51) Int. Cl. B62D 63/04; B60R 16/02; B60R 11/00; B62D 33/06; B60Q 9/00

(52) U.S. Cl. CPC B62D 63/04; B60R 16/0207; E01C 19/26; B62D 33/0621; B60Q 9/00; B60R 11/00

(57) ABSTRACT

A machine has a chassis and at least one propulsion device configured to support the chassis. The machine also has a machine control module configured to control operations of the machine. Further, the machine has a modular sensor bay configured to be attached to the chassis. The modular sensor bay includes a position sensor configured to determine a position of the machine. The modular sensor bay also includes an imaging device configured to generate an image of at least a portion of surroundings of the machine. The modular sensor bay includes a control module configured to control operations of position sensor and the imaging device. In addition, the modular sensor bay includes a harness configured to electrically connect the modular sensor bay with the machine control module.

### CROSS-REFERENCE TO RELATED APPLICATION

This application is based on and claims benefit of priority of U.S. Provisional Patent Application No. 62/985,473 filed on Mar. 5, 2020, the entire contents of which are incorporated herein by reference.

### TECHNICAL FIELD

The present disclosure relates generally to a modular sensor bay and more particularly to a modular sensor bay for a construction machine.

### BACKGROUND

Autonomous construction machines provide a number of benefits for automating simple, repetitive tasks at a construction site. In particular, such machines may be capable of autonomously navigating around the construction site and performing one or more tasks with little or no intervention by an operator. The operator may be remotely located from such construction machines and may be able to monitor multiple autonomous machines operating at the construction site.

However, occasionally certain tasks may be too complicated for an autonomous machine and may require intervention by an operator to operate the autonomous machine manually. It may also be necessary to operate an autonomous construction machine manually on certain portions of the construction site, or for some or all of certain tasks assigned to that machine. To allow for such manual operation, the autonomous machine may be equipped with an operator's cabin or platform. The operator's cabin or platform may include one or more control devices operable by an operator for manually controlling one or more operations of the autonomous machine. Thus, the operator's cabin or platform typically cannot be removed from the autonomous construction machine to make room for installing additional sensors and/or control modules that may be required for autonomous operation of the construction machine.

It may be possible to mount the additional sensors and/or control modules on top of the operator's cabin or platform. However, shipping height requirements often limit what can be mounted on top of the operator's cabin or platform of a machine. Thus, there is a need for a sensor assembly system or configuration that allows for quick installation and removal of sensors and/or control modules required for autonomous operation to machines that include an operator's cabin or platform.

The modular sensor bay of the present disclosure solves one or more of the problems set forth above and/or other problems of the prior art.

### SUMMARY

In one aspect, the present disclosure is directed to a machine. The machine may include a chassis and at least one propulsion device configured to support the chassis. The machine may also include a machine control module configured to control operations of the machine. Further, the machine may include a modular sensor bay configured to be attached to the chassis. The modular sensor bay may include a position sensor configured to determine a position of the machine. The modular sensor bay may also include an imaging device configured to generate an image of at least a portion of surroundings of the machine. Further, the modular sensor bay may include a control module configured to control operations of the position sensor and the imaging device. Additionally, the modular sensor bay may include a harness configured to electrically connect the modular sensor bay with the machine control module.

In another aspect, the present disclosure is directed to a machine, including a chassis, at least one propulsion device configured to support the chassis, and an operator platform removably attached to the chassis. The machine may also include a machine control module configured to control operations of the machine. Further, the machine may include a modular sensor bay configured to be attached to the operator platform. The modular sensor bay may include an imaging device configured to generate an image of at least a portion of surroundings of the machine. The modular sensor bay may also include a control module configured to control operations of the position sensor and the imaging device.

### BRIEF DESCRIPTION OF THE DRAWINGS

FIG. 1 is an illustration of an exemplary construction machine that includes an operator's cabin or platform;

FIG. 2 is an illustration of an exemplary modular sensor bay for the construction machine of FIG. 1; and

FIG. 3 is an illustration of an exemplary construction machine that does not include an operator's cabin or platform.

### DETAILED DESCRIPTION

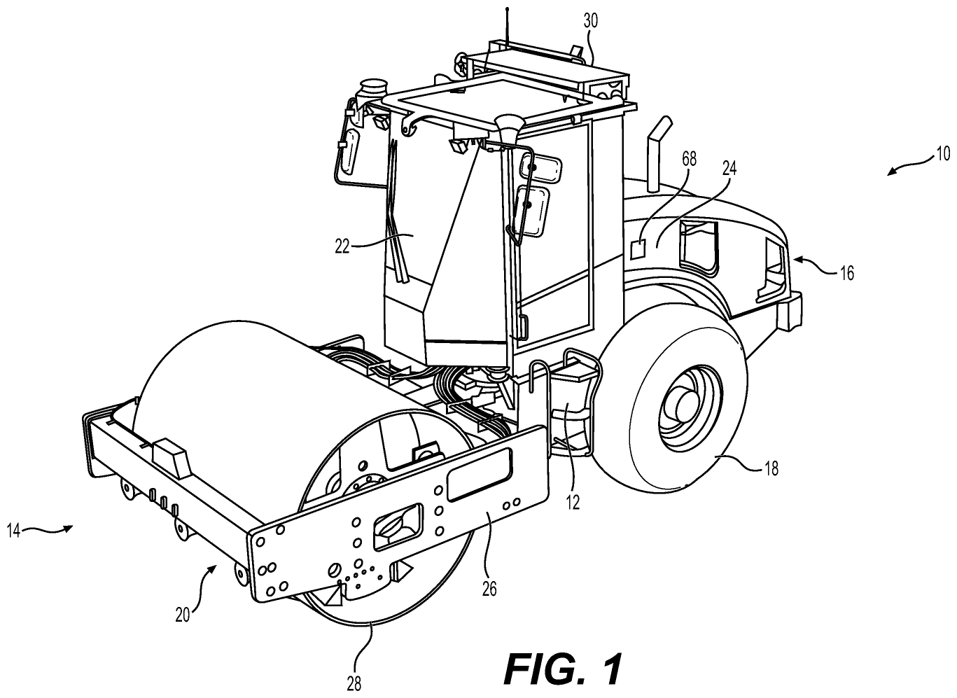

FIG. 1 illustrates an exemplary machine 10. In one exemplary embodiment as illustrated in FIG. 1, machine 10 may be a construction machines such as a compactor. It is contemplated, however, that machine 10 may be any other type of construction machine. For example, machine 10 may be a dump truck, an excavator, a front wheel loader, a continuous miner, a milling machine, an articulated truck, a backhoe loader, a multi-terrain loader, a forest machine, hydraulic mining shovel, a motor grader, an off-highway truck, or any other type of construction machine.

Machine 10 may include chassis 12, which may extend from front end 14 to rear end 16. Chassis 12 may have any shape (e.g. rectangular, triangular, square, etc.). Chassis 12 may be supported by one or more propulsion devices 18. In one exemplary embodiment as illustrated in FIG. 1, propulsion devices 18 may take the form of wheels. It is contemplated, however, that propulsion devices 18 may additionally or alternatively include tracks, rollers, etc. Some or all propulsion devices 18 may be steerable, allowing machine 10 to be turned towards the right or left during a forward or rearward motion of machine 10. In one exemplary embodiment as illustrated in FIG. 1, machine 10 may include working tool 20, which may include frame 26 attached to chassis 12 and a roller 28 attached to frame 26. Roller 28 may be a vibratory roller configured compact a ground surface on which machine 10 operates. Propulsion devices 18 and/or roller 28 may help support chassis 12 and/or working tool 20 on the ground surface. It is contemplated, however, that in other types of machine 10, frame 26 may be integral with chassis 12 and roller 28 may be replaced by one or more propulsion devices 18 that may support chassis 12 on the ground surface.

Machine 10 may include a power source 24, which may be configured to provide motive power to propulsion devices 18, roller 28, one or more machine components (e.g. motors, pumps, actuators, etc.), and/or one or more work tools associated with machine 10. In some exemplary embodiments, power source 24 may include an engine, which may be attached to chassis 12. Engine 24 may be any suitable type of internal combustion engine, such as a gasoline, diesel, natural gas, or hybrid-powered engine. It is contemplated, however, that in some exemplary embodiments, engine 24 may be driven by electrical power.

Machine 10 may include operator platform 22, which may be attached to chassis 12. In some exemplary embodiments, operator platform 22 may be in the form of an open-air platform that may or may not include a canopy. In other exemplary embodiments, operator platform 22 may be in the form of a partially or fully enclosed cabin as illustrated in, for example, FIG. 1. Operator platform 22 may include one or more controls, which may be used by an operator to operate and/or control machine 10. The controls may include, for example, one or more input devices, which may take the form of buttons, switches, sliders, levers, wheels, touch screens, or other input/output or interface devices. Machine 10 may also include machine control module 68 that may be configured to control operations of one or more components of machine 10. Machine 10 may include modular sensor bay 30, which may be configured to be attached to operator platform 22. In one exemplary embodiment as illustrated in FIG. 1, modular sensor bay 30 may be attachable to a roof of operator platform 22.

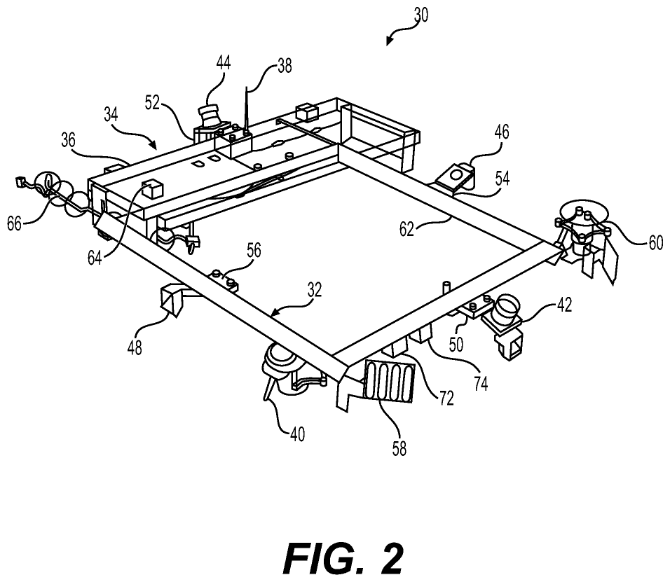

FIG. 2 illustrates an exemplary embodiment of modular sensor bay 30. Modular sensor bay 30 may include frame 32 and platform 34. Frame 32 may be a generally rectangular frame including generally elongated frame elements 62 connected to each other at their respective ends. It is contemplated that frame 32 may have any other type of shape, for example, circular, elliptical, square, triangular, polygonal, etc. It is also contemplated that in some exemplary embodiments, frame 32 may have a shape which may correspond to an outer perimeter of a roof of operator platform 22.

Platform 34 may be fixedly or removably attached to frame 32. In one exemplary embodiment as illustrated in FIG. 2, platform 34 may include mounting plate 36, which may be positioned spaced apart from and connected to frame 32. It is contemplated that in some exemplary embodiments, mounting plate 36 may be attached directly to frame 32 or may be integral with frame 32. Platform 34 may be configured to house one or more control modules 64 that may be used to control one or more parameters associated with machine 10, for example, when machine 10 is operated autonomously at a construction site. In one exemplary embodiment the one or more control modules 64 may be electronic control modules. As illustrated in FIG. 2, platform 34 may extend along a width of frame 32 (e.g. extending from a left side to a right side of machine 10). It is contemplated, however, that in some exemplary embodiments, platform 34 may extend only partway along the width of frame 32. It is also contemplated that in other exemplary embodiments, platform 34 may extend along part of or all of a length of frame 32 (e.g. in a front end 14 to rear end 16 direction). Although platform 34 has been illustrated in FIG. 2 as being positioned adjacent rear end 16, it is contemplated that platform 34 may be positioned on frame 32 in any location along the length or width of frame 32. It will be understood that as used in this disclosure the terms front and rear are relative terms, which may be determined based on a direction of travel of machine 10. Likewise, it will be understood that as used in this disclosure, the terms left and right are relative terms, which may be determined based on facing the direction of travel of machine 10.

A plurality of electronic components may be attached fixedly or removably to frame 32 and/or platform 34. For example, modular sensor bay 30 may include one or more communications modules attached to frame 32 and/or platform 34. The one or more communications modules may include for example antenna 38 and/or antenna 40. Antennas 38, 40 may help the one or more communications modules communicate with one or more remotely located devices (e.g. controllers, servers, etc.) It is also contemplated that one or more transceivers 72 and/or receivers 74 may be attached to modular sensor bay 30. Transceivers 72 and/or receivers 74 may cooperate with one or more of antennas 38, 40 to communicate with the one or more remotely located devices. Although illustrated separately in FIG. 2, it is contemplated that one or more transceivers 72 and/or receivers 74 may be located in the same housing. Antenna 38 may be a wireless communications antenna configured to allow components of modular sensor bay 30 and/or components of machine 10 to exchange data and/or instructions with a remote controller (e.g. remotely located server). Antenna 40 may be associated with a Global Positioning System (“GPS”) that may be used to determine a position of machine 10 at the construction site. For example, one or more GPS sensors 60 may be attached to frame 32 and may be configured to determine a position of machine 10 on the construction site. Antenna 40 may be configured to allow the one or more GPS sensors 60 to communicate with one or more GPS satellites used to determine a position of machine 10. Although FIG. 2 illustrates one each of antennas 38, 40, it is contemplated that modular sensor bay 30 may include any number of antennas 38, 40. Moreover, antennas 38, 40 are not limited to the positions and/or orientations illustrated in FIG. 2 and may be attached to frame 32 or platform 34 at other positions and in other orientations. Similarly, any number of GPS sensors 60 may be attached to one or more of frame 32 and/or platform 34 at various positions and in various orientations.

Modular sensor bay 30 may include one or more imaging devices 42, 44, 46, 48 configured to generate an image of at least a portion of the surroundings of machine 10. Imaging devices 42, 44, 46, 48 may include one or more mono or stereo optical cameras configured to capture and/or generate one or more 2D or 3D images. Image information may be encoded by the one or more imaging devices 42, 44, 46, 48 in any known format, such as 3D vector format, a Computer-Aided Design file, .FLV, .MP4, .AVI, .MPG, .MOV, .F4V, .VR, or any other image, video, or model format. In one exemplary embodiment, one or more of imaging devices 42, 44, 46, 48 may include a LIDAR sensor that may use a laser light to generate the one or more images via 3D scanning or laser scanning.

As illustrated in FIG. 2, imaging device 42 may be attached to frame 32 adjacent to or facing front end 14. Imaging device 44 may be attached to frame 32 adjacent to or facing rear end 16. Imaging devices 46, 48 may be attached to frame 32 facing a left and/or right side, respectively of machine 10. As also illustrated in FIG. 2, imaging devices 42, 44, 46, 48 may be attached fixedly or removably to frame 32 via mounts 50, 52, 54, 56, respectively. In one exemplary embodiment, one or more of mounts 50, 52, 54, 56 may be fixedly attached to frame 32, for example, by welding, brazing, etc. In another exemplary embodiment, one or more of mounts 50, 52, 54, 56 may be removably attached to frame 32 via one or more fasteners. It will be understood that mounts 50, 52, 54, 56 and/or imaging devices 42, 44, 46, 48 are not limited to the positions and/or orientations illustrated in FIG. 2 and may instead be attached to frame 32 and/or platform 34 at other positions and/or in other orientations. Furthermore, although four imaging devices 42, 44, 46, 48 and four mounts 50, 52, 54, 56 have been illustrated in FIG. 2, it is contemplated that modular sensor bay 30 may include any number of imaging devices 42, 44, 46, 48 and/or any number of mounts 50, 52, 54, 56.

Modular sensor bay 30 may also include one or more indicators 58 configured to display and/or indicate a status or operational condition of the one or more control modules, antennas 38, 40, imaging devices 42, 44, 46, 48, GPS sensors, and/or any other sensors or electronic equipment attached to frame 32 and/or platform 34. In one exemplary embodiment, indicator 58 may include one or more indicator lights (e.g. LED lights). Indicator 58 may be attached at any location to frame 32 and/or platform 34. In some exemplary embodiments indicator 58 may include one or more display devices configured to display the status and/or operational condition of the one or more components of modular sensor bay 30. Although only one indicator 58 is illustrated in FIG. 2, it is contemplated that modular sensor bay 30 may include any number of indicators 58.

It is further contemplated that modular sensor bay 30 may include one or more other sensors, for example, distance sensors, light sensors, obstacle detection sensors, position sensors, thermal sensors, speed sensors, infrared sensors, ultrasonic sensors, and/or other types of sensors used, for example, on construction machines. The one or more control modules, sensors (e.g. position or GPS sensors 60, etc.), antennas 38, 40, imaging devices 42, 44, 46, 48, indicators 58, and/or other components attached to modular sensor bay 30 may communicate with each other via wired or wireless connections. In one exemplary embodiment, the various components attached to modular sensor bay 30 may be connected to each other via wires, cables, etc. that may be routed along frame elements 62 and/or confined within platform 34. The one or more control modules, sensors (e.g. GPS sensors 60), antennas 38, 40, imaging devices 42, 44, 46, 48, indicators 58, and/or other components attached to modular sensor bay 30 may communicate with one or more control modules (e.g. machine control modules 68), sensors, and/or other electronic components of machine 10 through modular harness 66. Modular harness 66 may be a collection of one or more electrical power and/or data conduits that may be connected to the one or more components of machine 10 using, for example, quick disconnect power or data couplings. By consolidating the electrical power and/or data conduits into modular harness 66 and by using quick disconnect power or data couplings, modular sensor bay 30 may help ensure that modular sensor bay 30 can be attached to or detached from machine 10 relatively quickly and easily. It is also contemplated that in some exemplary embodiments, the one or more control modules, sensors (e.g. GPS sensors 60), antennas 38, 40, imaging devices 42, 44, 46, 48, indicators 58, and/or other components attached to modular sensor bay 30 may communicate with each other and/or with control modules or components of machine 10 via an ethernet connection, over a CAN bus, and/or any other type of data communication bus. In other exemplary embodiments, the one or more control modules, sensors (e.g. GPS sensors 60), antennas 38, 40, imaging devices 42, 44, 46, 48, indicators 58, and/or other components attached to modular sensor bay 30 may communicate with each other and/or with control modules or components of machine 10 via a wireless network (e.g. Wi-Fi, WiMAX, cellular, or other type of wireless network).

The one or more control modules of machine 10 and/or modular sensor bay 30 may include one or more controllers, which may be configured to receive inputs, data, and/or signals from the one or more sensors, cameras, etc. associated with machine 10 or modular sensor bay 30 and to control the operation of machine 10. The controllers associated with the one or more control modules may include or be associated with one or more processors, memory devices, and/or communication devices. Such controllers may embody a single microprocessor or multiple microprocessors, digital signal processors (DSPs), application-specific integrated circuit devices (ASICs), etc. Numerous commercially available microprocessors may be configured to perform the functions of these controllers. Various other known circuits may be associated with these controllers, including power supply circuits, signal-conditioning circuits, and communication circuits, etc.

The one or more memory devices associated with the one or more control modules may store, for example, data and/or one or more control routines or instructions. The one or more memory devices may embody non-transitory computer-readable media, for example, Random Access Memory (RAM) devices, NOR or NAND flash memory devices, and Read Only Memory (ROM) devices, CD-ROMs, hard disks, floppy drives, optical media, solid state storage media, etc.

Modular sensor bay 30 may be fixedly (e.g. by welding, by brazing, by riveting, etc.) or removably (e.g. by one or more fasteners, etc.) attached to operator platform 22. In one exemplary embodiment, it is contemplated that modular sensor bay 30 may be attached to operator platform 22 using lifting holes that may be already present on operator platform 22. In other exemplary embodiments, modular sensor bay 30 may include one or more clamping devices that may be configured to grip a periphery of, for example, a roof of operator platform 22. It is also contemplated that in some exemplary embodiments, operator platform 22 may be equipped with a frame and/or other structural members configured to be attached to the one or more clamping devices of modular sensor bay 30. It is contemplated that the one or more clamping devices associated with modular sensor bay 30 may be quick disconnect type clamping devices configured to allow ease of attachment and detachment of modular sensor bay 30 to operator platform 22. Although modular sensor bay 30 has been illustrated as being attached to a top of operator platform 22 in FIG. 2, it is contemplated that some or all portions of modular sensor bay 30 may be attached to a roof of operator platform 22, to one or more sides of operator platform 22, and/or to any other portion of machine 10. It is also contemplated that modular sensor bay 30 may include more than one module configured to be quickly connected to or disconnected from other modules of modular sensor bay 30. One or more of the modules of modular sensor bay 30 may be attached to one or more of a roof and/or sides of operator platform 22.

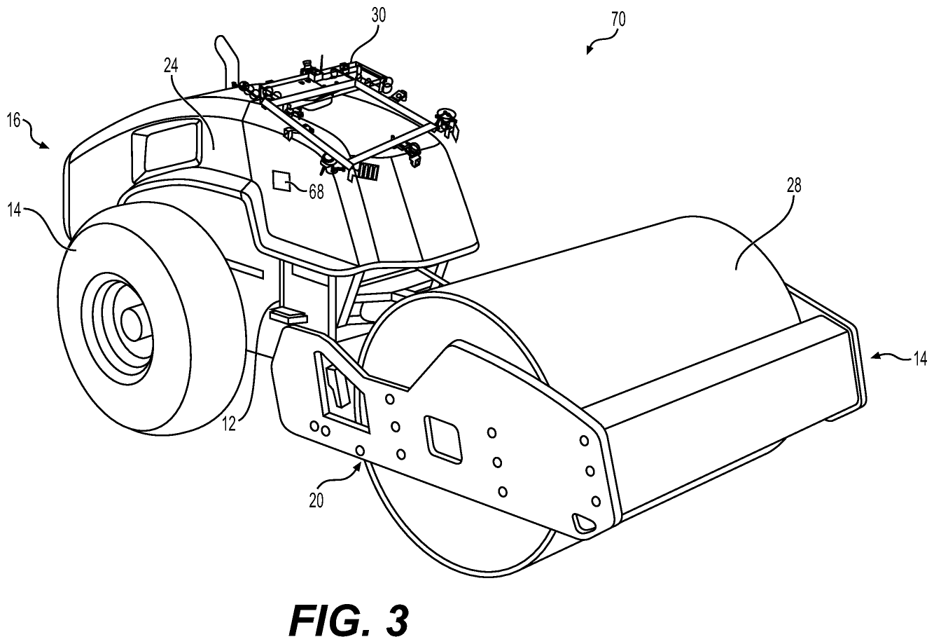

Although modular sensor bay 30 has been illustrated in FIG. 1 as being attachable to machine 10 that has an operator platform 22, it is contemplated that modular sensor bay 30 may also be attachable to, for example, a machine 70 that may not include an operator platform 22. FIG. 3 illustrates an exemplary embodiment of machine 70 that does not include an operator platform 22. Machine 70 may be an autonomous construction machine that may be operable autonomously or via remote-control. As illustrated in FIG. 3, machine 70, like machine 10, may include chassis 12, which may be supported by one or more propulsion devices 18 and/or one or more work tools 20. Work tool 20 of machine 70 may also include frame 26 which may be supported by roller 28 above the ground surface. Machine 70 may further include power source 24 that may provide motive power to the one or more propulsion devices 18, work tools 20, and/or to other components associated with machine 70.

As illustrated in FIG. 3, modular sensor bay 30 may be attached to machine 70. It is contemplated that modular sensor bay 30 may be fixedly or removably attached to chassis 12, frame 26, and/or any other portion of machine 70. As will be understood, the configuration of FIG. 3 may allow an operator to autonomously or remotely operate machine 70 by installing modular sensor bay 30 on machine 70. It is also contemplated that it may be possible to remove modular sensor bay 30 from machine 70, allowing installation of operator platform 22 onto machine 70 when it may be necessary to operate machine 70 manually.

Modular sensor bay 30 as described in this disclosure may provide several advantages. For example, the disclosed modular sensor bay 30 may allow machine 10 and/or machine 70 to be operated autonomously or remotely when required and may also allow machines 10, 70 to be operated manually when necessary. Moreover, because the disclosed modular sensor bay 30 may be assembled to or removed from machines 10, 70, machines 10, 70 may be transported between construction sites without modular sensor bay 30, thereby eliminating any dimensional restrictions associated with shipping and/or transporting machine 10 between construction sites. Additionally, because modular sensor bay 30 is not integral to machine 10 or 70 modular sensor bay 30 may be customized for various applications. For example, different combinations of sensors, imaging devices, control modules, etc. may be attached to different modular sensor bays 30 to accomplish specific tasks at a construction site. Moreover, different machines 10, 70 may be equipped with different modular sensor bays 30, each having the same or different combination of sensors, imaging devices, control modules, etc. Because modular sensor bay 30 may be quickly detached from and assembled to machines 10, 70, it may also be possible to swap out a malfunctioning modular sensor bay 30 on machines 10, 70 with a replacement modular sensor bay 30 without removing machines 10, 70 from the construction site for extended periods of time for maintenance.

It will be apparent to those skilled in the art that various modifications and variations can be made to the disclosed modular sensor bay for a construction machine. Other embodiments will be apparent to those skilled in the art from consideration of the specification and practice of the disclosed modular sensor bay for a construction machine. It is intended that the specification and examples be considered as exemplary only, with a true scope being indicated by the following claims and their equivalents.

What is claimed is:

1. A machine, comprising:
a chassis;
at least one propulsion device configured to support the chassis;
a machine control module configured to control operations of the machine; and
a modular sensor bay configured to be attached to the chassis, the modular sensor bay including:
an imaging device configured to generate an image of at least a portion of surroundings of the machine;
a control module configured to control operations of the imaging device; and
a harness configured to electrically connect the modular sensor bay with the machine control module.

2. The machine of claim 1, wherein the modular sensor bay includes:
a frame; and
a mounting plate spaced apart from and connected to the frame, wherein the control module is configured to be attached to the mounting plate.

3. The machine of claim 2, wherein the imaging device is configured to be attached to the frame.

4. The machine of claim 1, wherein the modular sensor bay includes a position sensor configured to determine a position of the machine.

5. The machine of claim 4, wherein the position sensor is a GPS sensor.

6. The machine of claim 1, wherein the imaging device and the control module communicate with each other via a wired connection.

7. The machine of claim 6, wherein the wired connection is a CAN bus.

8. The machine of claim 1, wherein the imaging device and the control module communicate with each other via a wireless connection.

9. The machine of claim 1, wherein the imaging device includes a LIDAR sensor.

10. The machine of claim 1, further including an operator platform attached to the chassis.

11. The machine of claim 10, wherein the modular sensor bay is fixedly attached to the operator platform.

12. The machine of claim 10, wherein the modular sensor bay includes a clamp configured to removably connect the modular sensor bay to the operator platform.

13. The machine of claim 10, wherein the operator platform includes at least one mounting hole, and the modular sensor bay is attached to the operator platform using the at least one mounting hole.

14. The machine of claim 10, wherein at least a portion of the modular sensor bay is attached to one or more sides of the operator platform.

15. A machine, comprising:
a chassis;
at least one propulsion device configured to support the chassis;
an operator platform removably attached to the chassis;
a machine control module configured to control operations of the machine; and
a modular sensor bay configured to be attached to the operator platform, the modular sensor bay including:
an imaging device configured to generate an image of at least a portion of surroundings of the machine; and
a control module configured to control operations of the imaging device.

16. The machine of claim 15, further including a modular harness including one or more connections configured to electrically connect the modular sensor bay with one or more components of the machine.

17. The machine of claim 16, wherein the modular harness includes at least one quick disconnect coupling.

18. The machine of claim 15, wherein the modular sensor bay includes at least one indicator configured to display an operational condition of at least one of the imaging device and the control module.

19. The machine of claim 15, wherein the control module is one of a plurality of control modules that are removably connectable to the modular sensor bay and to each other.

20. The machine of claim 15, wherein the machine is an autonomous construction machine.
